(19) United States
(12) Patent Application Publication
(10) Pub. No.: US 2025/0340087 A1
(43) Pub. Date: Nov. 6, 2025

(54) TIRE COMPRISING PAIRS OF TRANSVERSE NOTCHES FOR SOUND DISPERSION

(71) Applicant: COMPAGNIE GENERALE DES ETABLISSEMENTS MICHELIN, Clermont-Ferrand (FR)

(72) Inventors: BENOIT DURAND-GASSELIN, Clermont-Ferrand (FR); MIGUEL FERNANDEZ, Clermont-Ferrand (FR)

(21) Appl. No.: 18/871,211

(22) PCT Filed: May 24, 2023
(86) PCT No.: PCT/EP2023/063956

§ 371 Date: Dec. 3, 2024

(30) Foreign Application Priority Data
Jun. 3, 2022 (FR) 2205356

(51) Int. Cl. B60C 11/12; B60C 11/03

(52) U.S. Cl. CPC B60C 11/1236; B60C 11/0306; B60C 2200/04

(57) ABSTRACT

A tire (10) comprises transverse cuts (80, 90) formed in axially lateral portions (P1, P2). The transverse cuts (80, 90) formed in each axially lateral portion (P1, P2) comprise at least one sound dispersion pair of first and second transverse cuts (801, 802, 811, 812). Each axially inner portion (861, 862, 871, 872) of each first and second transverse cut (801, 802, 811, 812) of the sound dispersion pair extends in an overall direction respectively forming a first non-zero mean angle with the axial direction (Y) that is different from a second non-zero mean angle (F1, F2, F11, F12) with the axial direction (Y).

The present invention relates to a tyre for a passenger vehicle. A tyre is understood to be a casing intended to form a cavity by cooperating with a support element, for example a rim, this cavity being able to be pressurized to a pressure higher than atmospheric pressure. A tyre according to the invention has a structure of substantially toroidal shape exhibiting symmetry of revolution about a main axis of the tyre.

A tyre for a passenger vehicle, sold under the MICHELIN® trade name in the PRIMACY 4® range, is known from the prior art. Such a tyre comprises a tread intended to come into contact with the ground, when the tyre is running, via a tread surface.

The tread comprises main circumferential cuts having a depth greater than or equal to 50% of the tread pattern height and comprising first and second axially outer main circumferential cuts axially on either side of the median plane of the tyre. The first and second axially outer main circumferential cuts are the axially outermost main circumferential cuts of the tread.

The tread comprises a first axially lateral portion axially on the outside of the first axially outer main circumferential cut and a second axially lateral portion axially on the outside of the second axially outer main circumferential cut. The tread also comprises transverse cuts partially formed in each first and second axially lateral portion.

Owing to increasingly stringent regulations governing the external noise generated by the tyre, the tyre of the prior art generates external noise which is to be reduced as far as possible in normal use conditions but also in use conditions that are far removed from normal use conditions. Use conditions is understood notably to mean the conditions relating to speed, pressure and load of the tyre, but also the width of the rim on which the tyre is mounted.

An aim of the invention is therefore to reduce the external noise generated by the tyre by reducing the noise generated by the transverse cuts formed in the first and second axially lateral portions in a very wide variety of use conditions.

To that end, the invention relates to a tyre for a passenger vehicle, comprising a tread intended to come into contact with the ground, via the tread surface, when the tyre is running, the tread comprising:
main circumferential cuts having a depth greater than or equal to 50% of the tread pattern height, comprising first and second axially outer main circumferential cuts arranged axially on either side of the median plane of the tyre, the first and second axially outer main circumferential cuts being the axially outermost main circumferential cuts of the tread,
a first axially lateral portion arranged axially on the outside of the first axially outer main circumferential cut and extending axially from a first axial edge of the tread surface to an axially outer edge of the first axially outer main circumferential cut,
a second axially lateral portion arranged axially on the outside of the second axially outer main circumferential cut and extending axially from a second axial edge of the tread surface to an axially outer edge of the second axially outer main circumferential cut, the tread comprising at least transverse cuts formed at least partially in at least one of the first and second axially lateral portions,
   at least one of the first and second axially lateral portions comprising an axial portion having an axial width equal to 50% of the axial width of said at least one of the first and second axially lateral portions and extending axially outwards from the axially outer edge of said first or second axially outer main circumferential cut from which said at least one of the first and second axially lateral portions extends,
   each transverse cut comprising an axially inner portion extending in the axial portion of said at least one of the first and second axially lateral portions,
   the transverse cuts formed in said at least one of the first and second axially lateral portions comprising at least one sound dispersion pair comprising a first and a second transverse cut, each axially inner portion of each first and second transverse cut of the sound dispersion pair having respectively a width La1, La2 such that:
1≤La1/La2≤2.5 with La1>1.5 mm and La2>1.5 mm,
1≤La1/La2≤3.0 with La1>1.5 mm and La2≤1.5 mm,
1≤La1/La2≤4.0 with La1≤1.5 mm,
   each axially inner portion of each first and second transverse cut of the or each sound dispersion pair extends in an overall direction respectively forming a first and a second non-zero mean angle with the axial direction,
   the first mean angle of the axially inner portion of the first transverse cut of the or each sound dispersion pair is different from the second mean angle of the axially inner portion of the second transverse cut of said sound dispersion pair.

The invention makes it possible to reduce the external noise generated by the transverse cuts formed in at least one of the first and second axially lateral portions in a very wide variety of use conditions. In other words, the tyre according to the invention has considerable multifunctionality regarding its performance in terms of external noise.

Specifically, the inventors behind the invention have discovered that the external noise generated by the transverse cuts was all the greater when the edges of the transverse cuts coincided with the edge of the contact patch of the tyre.

The shape of the contact patch, and therefore its edge, depend on the use conditions. As a result, in some use conditions the transverse cuts of a given tyre can coincide with the edge of the contact patch of the tyre to a considerable extent and therefore generate a relatively loud external noise, whereas in other use conditions the transverse cuts of this same tyre can coincide with the edge of the contact patch of the tyre to a small extent or not at all and therefore generate a relatively quiet external noise. Providing transverse cuts of which the mean angle of the axial portions is not identical reduces the occurrence of the coincidence between the edge corners of the transverse cuts and the edge of the contact patch of the tyre irrespective of the use conditions and therefore the external noise generated by the tyre.

This explains the sound dispersion function associated with the pair of transverse cuts and with their portions that make it possible to disperse the noise generated by the transverse cuts in a very wide variety of use conditions.

The feature according to which each axially inner portion of each first and second transverse cut of the sound dispersion pair respectively has a width La1, La2 such that:
1≤La1/La2≤2.5 with La1>1.5 mm and La2>1.5 mm,
1≤La1/La2≤3.0 with La1>1.5 mm and La2≤1.5 mm,
1≤La1/La2≤4.0 with La1≤1.5 mm,
   makes it possible to consider transverse cuts having comparable lengths and therefore comparable behaviour without the cuts strictly having the same width.

In variants, it may be envisaged that the axially inner portion does not lead into one of the first and second axially outer main circumferential cuts adjacent to it. In these variants, the transverse cuts are said to be blind. In other variants, the axially inner portion leads into one of the first and second axially outer main circumferential cuts adjacent to it. The mobility of the tread pattern is thus promoted compared to the cases of blind transverse cuts, thereby improving the flattening of the tyre and consequently the rolling resistance.

Conventionally, the tread surface is axially delimited by the first and second axial edges. The first and second axial edges of the tread surface are determined on a tyre mounted on a nominal rim and inflated to the nominal pressure in accordance with the European Tyre and Rim Technical Organisation, or “ETRTO”, standard of 2021. The first and second axial edges of the tread surface are arranged on either side of the median plane of the tyre and formed by lines substantially parallel to the circumferential direction of the tyre. If there is an obvious boundary between the tread surface and the rest of the tyre, the first and second axial edges of the tread surface are simply determined. If the tread surface is continuous with the outer surfaces of the sidewalls of the tyre, the first and second axial edges may be determined taking into consideration that each first and second axial edge passes, in each meridian section plane, through the point at which the angle between the tangent to the tread surface and a straight line parallel to the axial direction passing through this point is equal to 30°. When, in a meridian section plane, there are several points at which said angle is equal, in terms of absolute value, to 30°, the radially outermost point is used.

The mean angle of a portion is determined by taking the straight line extending between two end points of the portion, the two end points being situated at the ends of each portion, equidistant from the leading and trailing edges of each end of the portion.

Of course, the transverse cuts, notably the first, second and optionally third transverse cuts for sound dispersion, are separate from one another. As a result, the transverse cuts, notably the first, second and optionally third transverse cuts for sound dispersion, are circumferentially offset from one another. There is therefore no direct axial communication between the transverse cuts, notably the first, second and optionally third transverse cuts for sound dispersion. As a result, either there is no communication between the transverse cuts, notably the first, second and optionally third transverse cuts for sound dispersion, or, if there is communication between them, it is done via a cut which is not a transverse cut, for example a circumferential cut. The transverse cuts, notably the first, second and optionally third transverse cuts for sound dispersion, thus do not axially continue one another.

The or each first and second axially lateral portion of the tread can of course comprise other transverse cuts that do not have the features of the transverse cuts in accordance with the invention, notably the features relating to the width of their axially inner portion, and also circumferential cuts having a depth strictly less than 50% of the tread pattern height.

A cut or cut portion has, on the tread surface, two main characteristic dimensions: a width and a curvilinear length such that the curvilinear length is at least equal to twice the width. A cut or cut portion is therefore delimited by at least two main lateral faces determining its curvilinear length and connected by a bottom, the two main lateral faces being distant from each other by a non-zero distance referred to as the width of the cut or cut portion.

On a new tyre, the width of a cut or cut portion is the maximum distance between the two main lateral faces measured, by default and when the cut or cut portion is not chamfered, at a radial point coinciding with the tread surface, and by default and when the cut or cut portion is chamfered, at the radially outermost radial point of the cut or cut portion and radially on the inside of the chamfer. The width is measured substantially perpendicularly in relation to the main lateral faces. If a width other than the default width is specified, for example a width at a particular point, the width is equal to the distance between the two main lateral faces at the particular point of the cut or cut portion.

On a new tyre, the depth of a cut or cut portion is the maximum radial distance between the bottom of the cut or portion and its projection onto the ground when the tyre is running. The maximum value for the depths of the cuts is referred to as the tread pattern height.

A cut or cut portion can be transverse or circumferential.

A transverse cut is such that the cut extends in an overall direction that forms an angle strictly greater than 30°, preferably greater than or equal to 45° with the circumferential direction of the tyre, which is to say forms an angle less than or equal to 60°, preferably strictly less than 45° with the axial direction of the tyre. The overall direction is the shortest curve joining the two ends of the cut and parallel to the tread surface. A transverse cut or portion can be continuous, which is to say not interrupted by a tread pattern block or another cut, such that the two main lateral faces that determine its length are uninterrupted over the length of the transverse cut or portion. A transverse cut can equally be discontinuous, which is to say interrupted by one or more tread pattern blocks and/or one or more cuts, such that the two main lateral faces that determine its length are interrupted by one or more tread pattern blocks and/or one or more cuts.

A circumferential cut is such that the cut or portion extends in an overall direction that forms an angle less than or equal to 30°, preferably less than or equal to 10° with the circumferential direction of the tyre, which is to say that forms an angle strictly greater than 60°, preferably strictly greater than 80° with the axial direction of the tyre. The overall direction is the shortest curve joining the two ends of the cut and parallel to the tread surface. In the case of a continuous circumferential cut, the two ends coincide with each other and are joined by a curve that goes all the way around the tyre. A circumferential cut can be continuous, which is to say not interrupted by a tread pattern block or another cut, such that the two main lateral faces that determine its length are uninterrupted all the way around the tyre. A circumferential cut may equally be discontinuous, which is to say interrupted by one or more tread pattern blocks and/or one or more other cuts, such that the two main lateral faces that determine its length are interrupted by one or more tread pattern blocks and/or one or more other cuts over a full circuit of the tyre.

In the case of a transverse cut or transverse cut portion, the lateral faces are referred to as leading face and trailing face and are each respectively provided with a leading edge and a trailing edge, the leading edge being the edge that, for a given circumferential line, enters the contact patch before the trailing edge.

In embodiments for optionally improving the braking on dry ground, the or each transverse cut is chamfered. A chamfer on a transverse cut may be a straight chamfer or rounded chamfer. A straight chamfer is formed by a planar face that is inclined with respect to the leading or trailing face that it continues as far as the leading or trailing edge circumferentially delimiting the transverse cut. A rounded chamfer is formed by a curved face that merges tangentially into the leading or trailing face that it continues. A chamfer on a transverse cut is characterized by a height and a width which are respectively equal to the radial distance and to the distance in a direction perpendicular to the leading or trailing faces between the point common to the leading or trailing face continued by the chamfer and the leading or trailing edge circumferentially delimiting the transverse cut.

In some embodiments for optionally improving the braking on wet ground and also the transverse grip on dry ground, at least one of the main circumferential cuts is chamfered. A chamfer on a circumferential cut can be a straight chamfer or rounded chamfer. A straight chamfer is formed by a planar face that is inclined with respect to the axially inner and outer face that it continues as far as the axially inner or outer edge axially delimiting the circumferential cut. A rounded chamfer is formed by a curved face that merges tangentially into the axially inner or outer face that it continues. A chamfer on a circumferential cut is characterized by a height and a width that are respectively equal to the radial distance and to the axial distance between the point common to the axially inner or outer face continued by the chamfer and the axially inner or outer edge axially delimiting the circumferential cut.

The tyre according to the invention has a substantially toric shape about an axis of revolution substantially coinciding with the axis of rotation of the tyre. This axis of revolution defines three directions conventionally used by a person skilled in the art: an axial direction, a circumferential direction and a radial direction.

The expression “axial direction” means the direction substantially parallel to the axis of revolution of the tyre, which is to say the axis of rotation of the tyre.

The expression “circumferential direction” means the direction that is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The median plane of the tyre (denoted M) is understood to be the plane perpendicular to the axis of rotation of the tyre, which is situated axially mid-way between the two beads and passes through the axial middle of the crown reinforcement.

The expression “equatorial circumferential plane of the tyre” (denoted E) means, in a meridian section plane, the plane passing through the equator of the tyre, perpendicular to the median plane and to the radial direction. The equator of the tyre is, in a meridian section plane (plane perpendicular to the circumferential direction and parallel to the radial and axial directions), the axis parallel to the axis of rotation of the tyre and situated equidistantly between the radially outermost point of the tread that is intended to be in contact with the ground, and the radially innermost point of the tyre that is intended to be in contact with a support, for example a rim, the distance between these two points being equal to H.

The expression “meridian plane” means a plane parallel to and containing the axis of rotation of the tyre and perpendicular to the circumferential direction.

The expressions “radially inner/radially on the inside” and “radially outer/radially on the outside” mean closer to the axis of rotation of the tyre and further away from the axis of rotation of the tyre, respectively. The expressions “axially inner/axially on the inside” and “axially outer/axially on the outside” mean closer to the median plane of the tyre and further away from the median plane of the tyre, respectively.

A bead is understood to be the portion of the tyre intended to allow the tyre to be attached to a mounting support, for example a wheel comprising a rim. Thus, each bead is notably intended to be in contact with a flange of the rim allowing it to be attached.

Any range of values denoted by the expression “between a and b” represents the range of values extending from more than a to less than b (that is to say excluding the end-points a and b), whereas any range of values denoted by the expression “from a to b” means the range of values extending from a up to b (that is to say including the strict end-points a and b).

In preferred embodiments of the invention, the tyres are intended for passenger vehicles as defined in accordance with the European Tyre and Rim Technical Organisation, or “ETRTO”, standard of 2021. Such a tyre has a cross section in a meridian section plane that is characterized by a section height H and a nominal section width S within the meaning of the European Tyre and Rim Technical Organisation, or “ETRTO”, standard of 2021, such that the ratio H/S, expressed as a percentage, is at most equal to 90, preferably at most equal to 70, and is at least equal to 30, and the nominal section width S is at least equal to 115 mm, preferably at least equal to 175 mm, and at most equal to 385 mm, preferably at most equal to 315 mm. Moreover, the diameter at the flange D, defining the diameter of the rim on which the tyre is mounted, is at least equal to 12 inches, preferably at least equal to 16 inches and at most equal to 24 inches.

In preferred embodiments of the invention, the tyres are “summer” tyres. Summer tyres are understood to be tyres that are not “4-season” or “all-season” tyres, or “winter” tyres.

Winter tyres are notably identified by a M+S marking (M+S being short for “Mud+Snow”) and/or 3PMSF marking (3PMSF being short for “3 Peak Mountain Snow Flake”). 4-season or all-season tyres also have M+S and/or 3PMSF markings owing to their performance on snow. A summer tyre thus does not have a M+S marking or a 3PMSF marking.

The tread optimally but optionally comprises at least transverse cuts formed in each first and second axially lateral portion,

each first and second axially lateral portion comprising an axial portion having an axial width equal to 50% of the axial width respectively of each first and second axially lateral portion and extending axially outwards from each axially inner edge respectively of each first and second axially outer main circumferential cut from which each first and second axially lateral portion respectively extends,
each transverse cut comprising an axially inner portion extending in the axial portion of said first or second axially lateral portion,
the transverse cuts formed in the first axially lateral portion comprising at least one first sound dispersion pair comprising a first and a second transverse cut, the transverse cuts formed in the second axially lateral portion comprising at least one second sound dispersion pair comprising a first and a second transverse cut,
each axially inner portion of each first and second transverse cut of each first and second sound dispersion pair respectively having a width La1, La2 such that:
1≤La1/La2≤2.5 with La1>1.5 mm and La2>1.5 mm,
1≤La1/La2≤3.0 with La1>1.5 mm and La2≤1.5 mm,
1≤La1/La2≤4.0 with La1≤1.5 mm,
   each axially inner portion of each first and second transverse cut of each first and second sound dispersion pair extends in an overall direction respectively forming a first and a second non-zero mean angle with the axial direction,
   the first mean angle of the axially inner portion of the first transverse cut of each first and second sound dispersion pair is different from the second mean angle of the axially inner portion of the second transverse cut respectively of each first and second sound dispersion pair.

In preferred embodiments, each axially inner portion of each first and second transverse cut of the sound dispersion pair respectively has a width La1, La2 such that:
1≤La1/La2≤2.1 with La1>1.5 mm and La2>1.5 mm,
1≤La1/La2≤2.4 with La1>1.5 mm and La2≤1.5 mm,
1≤La1/La2≤3.2 with La1≤1.5 mm.

In advantageous embodiments, the axially inner portion of each first and second transverse cut of the or each sound dispersion pair has a width ranging from 0.2 mm to 2.2 mm, preferably from 0.2 mm to 1.0 mm, more preferentially from 0.2 mm to 0.6 mm and more preferentially still from 0.2 mm to 0.5 mm. Limiting the width of the axial portion limits the noise generated by the sound dispersion cut.

In advantageous embodiments, the axially inner portion of each first and second transverse cut of the or each sound dispersion pair has a depth ranging from 2.0 mm to 5.5 mm, preferably ranging from 3.0 mm to 5.0 mm.

Each main circumferential cut optionally and preferably has a depth greater than or equal to 75%, and more preferentially greater than or equal to 90%, of the tread pattern height.

In embodiments in which the main circumferential cuts are relatively deep, each main circumferential cut has a depth ranging from 4.0 mm to the tread pattern height, preferably ranging from 5.0 mm to the tread pattern height and more preferentially ranging from 5.5 mm to the tread pattern height.

In embodiments in which the main circumferential cuts are relatively wide main circumferential grooves, each main circumferential cut has an axial width greater than or equal to 1.0 mm, preferably greater than or equal to 5.0 mm and more preferentially ranging from 5.0 mm to 20.0 mm.

In optional embodiments, it may also be envisaged that at least one of the first and second axially lateral portions comprises at least one additional circumferential cut having a depth strictly less than 50% of the tread pattern height, preferably less than or equal to 30% of the tread pattern height and more preferably ranging from 10% to 30% of the tread pattern height.

Each first and second non-zero mean angle of the axially inner portion of each first and second transverse cut of the or each sound dispersion pair is optionally but advantageously less than or equal to 50°, preferably less than or equal to 40°, and more preferentially ranges from 5° to 40°.

If the mean angle is too small, there is an increased risk that the edge corners of the transverse cuts for sound dispersion and the edge of the contact patch of the tyre coincide in most use conditions and thus the noise generated by the tyre increases. Conversely, if the mean angle is too large, there is an increased risk of the tyre pulling, which is to say an increased risk of generating a force in the axial direction of the tyre.

In some embodiments, the difference in terms of absolute value between the first mean angle and the second mean angle of the or each sound dispersion pair is less than or equal to 40°, preferably less than or equal to 30°. Although the use conditions of the tyre can be significantly different, it would still be an exceptional case for the use conditions to be so different that it would be necessary to provide an excessive deviation between the values of the angles.

In yet other embodiments, the difference in terms of absolute value between the first mean angle and the second mean angle of the or each sound dispersion pair is greater than or equal to 5°, preferably greater than or equal to 10°. Conversely, the greater the degree to which the value of the deviation between the angles is increased, the more different the conditions in which the noise can be reduced can be.

In embodiments in which the invention is applied to a significant number of transverse cuts of the or each first and second axially lateral portion, the first and second mean angles being equal to values taken from a list of at least first and second different values:
the mean angle of the axially inner portion of at least 25%, preferably at least 50% and more preferentially at least 75% of the transverse cuts of said at least one of the first and second axially lateral portions is equal to one of the at least first and second different values,
each axially inner portion of each transverse cut of which the mean angle is equal to one of the at least first and second different values has a width La such that:
   1≤Lamax/La≤2.5, preferably 1≤Lamax/La≤2.1, with Lamax>1.5 mm and La>1.5 mm,
   1≤Lamax/La≤3.0, preferably 1≤Lamax/La≤2.4, with Lamax>1.5 mm and La≤1.5 mm,
   1≤Lamax/La≤4.0, preferably 1≤Lamax/La≤3.2, with Lamax≤1.5 mm,
where Lamax is the maximum value of the widths of the axially inner portions of at least 25%, preferably at least 50% and more preferentially at least 75% of the transverse cuts of which the mean angle is equal to one of the at least first and second different values.

Thus, increasing the number of pairs of transverse cuts having different mean angles promotes the dispersion of noise in different use conditions.

In these embodiments, it is advantageous if:
each mean angle of the axially inner portion of at least 15%, preferably at least 25% of the transverse cuts of said at least one of the first and second axially lateral portions is equal to the first value, and
each mean angle of the axially inner portion of at least 15%, preferably at least 25% of the transverse cuts of said at least one of the first and second axially lateral portions is equal to the second value.

As a result, it is ensured both that a significant number of transverse cuts has a mean angle value equal to one of the first and second values and that each first and second value is reached by a significant number of transverse cuts with respect to the total numbers of transverse cuts of the or each first and second axially lateral portion.

In optional embodiments for dispersing the noise even more advantageously, the transverse cuts formed at least partially in said at least one of the first and second axially lateral portions comprise at least one sound dispersion trio comprising a first, a second and a third transverse cut,

each first, second and third transverse cut of the or each sound dispersion trio comprises an axially inner portion extending in the axial portion of said at least one of the first and second axially lateral portions,
each axially inner portion of each first, second and third transverse cut of the sound dispersion trio respectively having a width La1≥La2≥La3 such that:
1≤La1/La3≤2.5, preferably 1≤La1/La3≤2.1 with La1>1.5 mm and La3>1.5 mm,
1≤La1/La3≤3.0, preferably 1≤La1/La3≤2.4 with La1>1.5 mm and La3≤1.5 mm,
1≤La1/La3≤4.0, preferably 1≤La1/La3≤3.2 with La1≤1.5 mm,
   each axially inner portion of each first, second and third transverse cut of the or each sound dispersion trio extends in an overall direction respectively forming a first, a second and a third non-zero mean angle with the axial direction,
   the first, second and third mean angles of the axially inner portions of the first, second and third transverse cuts of the or each sound dispersion trio are different in pairs.

In other words, the first mean angle is different from the second mean angle, the second mean angle is different from the third mean angle, and the first mean angle is different from the third mean angle.

By taking three mean angle values, a greater number of use conditions in which noise is effectively dispersed is taken into account. In the case of a mould comprising multiple different patterns, a number of mean angles equal to the number of different patterns will advantageously be chosen so as to limit the design complexity of the mould and make it such that each pattern corresponds to one, and just one, mean angle.

Similarly to what is optionally provided for the pairs of transverse cuts, each first, second and third non-zero mean angle of the axially inner portion of each first, second and third transverse cut of the or each sound dispersion trio is less than or equal to 50°, preferably less than or equal to 40°, and more preferentially ranges from 5° to 40°.

Similarly to what is optionally provided for the pairs of transverse cuts, each difference in terms of absolute value between:
the first mean angle and the second mean angle of the or each sound dispersion trio,
the second mean angle and the third mean angle of the or each sound dispersion trio,
the first mean angle and the third mean angle of the or each sound dispersion trio, is less than or equal to 40°, preferably less than or equal to 30°, and/or is greater than or equal to 5°, preferably greater than or equal to 10°.

Similarly to what is optionally provided for the pairs of transverse cuts, the first, second and third mean angles being equal to values taken from a list of at least first, second and third values that are different in pairs:
the mean angle of the axially inner portion of at least 25%, preferably at least 50% and more preferentially at least 75% of the transverse cuts of said at least one of the first and second axially lateral portions is equal to one of the at least first, second and third different values,
each axially inner portion of each transverse cut of which the mean angle is equal to one of the at least first, second and third different values has a width La such that:
   1≤Lamax/La≤2.5, preferably 1≤Lamax/La≤2.1, with Lamax>1.5 mm and La>1.5 mm,
   1≤Lamax/La≤3.0, preferably 1≤Lamax/La≤2.4, with Lamax>1.5 mm and La≤1.5 mm,
   1≤Lamax/La≤4.0, preferably 1≤Lamax/La≤3.2, with Lamax≤1.5 mm,
where Lamax is the maximum value of the widths of the axially inner portions of at least 25%, preferably at least 50% and more preferentially at least 75% of the transverse cuts of which the mean angle is equal to one of the at least first, second and third values that are different in pairs.

Still similarly to what is optionally provided for the pairs of transverse cuts,
each mean angle of the axially inner portion of at least 15%, preferably at least 25% of the transverse cuts of said at least one of the first and second axially lateral portions is equal to the first value,
each mean angle of the axially inner portion of at least 15%, preferably at least 25% of the transverse cuts of said at least one of the first and second axially lateral portions is equal to the second value, and
each mean angle of the axially inner portion of at least 15%, preferably at least 25% of the transverse cuts of said at least one of the first and second axially lateral portions is equal to the third value.

In some embodiments, the first and second transverse cuts of the or each sound dispersion pair are circumferentially adjacent.

This reduces the occurrence of two circumferentially adjacent transverse cuts generating the same external noise in given use conditions. The dispersion of the noise generated in given use conditions is thus promoted, in particular if these given use conditions cause the edges of at least some of the transverse cuts to coincide with the edge of the contact patch of the tyre.

The expression “circumferentially adjacent” means that no transverse cut having an axially inner portion having a width La such that:
1≤La1/La2≤2.5, preferably 1≤La1/La2≤2.1 with La1>1.5 mm and La2>1.5 mm,
1≤La1/La2≤3.0, preferably 1≤La1/La2≤2.4 with La1>1.5 mm and La2≤1.5 mm,
1≤La1/La2≤4.0, preferably 1≤La1/La2≤3.2 with La1≤1.5 mm,
   is arranged circumferentially between the transverse cuts of the sound dispersion pair.

Similarly, in the case of a trio of circumferentially adjacent transverse cuts, some embodiments are such that the first, second and third transverse cuts of the or each sound dispersion trio are circumferentially adjacent.

The expression “circumferentially adjacent” means, similarly to a sound dispersion pair, that no transverse cut having an axially inner portion having a width La such that:
1≤La1/La3≤2.5, preferably 1≤La1/La3≤2.1 with La1>1.5 mm and La2>1.5 mm,
1≤La1/La3≤3.0, preferably 1≤La1/La3≤2.4 with La1>1.5 mm and La2≤1.5mm,
1≤La1/La3≤4.0, preferably 1≤La1/La3≤3.2 with La1≤1.5 mm,
   is arranged circumferentially between the transverse cuts of the sound dispersion trio.

The difference in terms of absolute value between the first mean angle and the second mean angle of the or each sound dispersion pair of circumferentially adjacent first and second transverse cuts is optionally but advantageously less than or equal to 20°.

This is because, if axial portions having excessively different mean angles belong to circumferentially adjacent transverse cuts for sound dispersion, there is the risk of obtaining an excessive difference in stiffness between the adjacent blocks of rubber, thereby possibly causing uneven wear. In this case, limiting the difference between these mean angles reduces the difference in stiffness between these adjacent blocks of rubber, thereby promoting even wear of the tread.

The difference in terms of absolute value between the first mean angle and the second mean angle of the or each sound dispersion pair of circumferentially adjacent first and second transverse cuts is optionally but advantageously greater than or equal to 5°, preferably greater than or equal to 10°.

Sufficient differentiation between the mean angles reduces the noise generated by the adjacent transverse cuts of the tyre in sufficiently different use conditions.

Similarly to what has been optionally provided for the pairs of transverse cuts, the difference in terms of absolute value between one of the first, second and third mean angles and at least one of the others of the first, second and third mean angles of the or each sound dispersion trio of circumferentially adjacent first, second and third transverse cuts is less than or equal to 20° and/or greater than or equal to 5°, preferably greater than or equal to 10°.

In preferred embodiments, with the tread comprising N circumferentially adjacent transverse cuts forming N pairs of transverse cuts which are circumferentially adjacent in a circumferential direction of rotation around the tyre, the width La of each axially inner portion of each of the N circumferentially adjacent transverse cuts is such that:
1≤Lamax/La≤2.5, preferably 1≤Lamax/La≤2.1, with Lamax>1.5 mm and La>1.5 mm,
1≤Lamax/La≤3.0, preferably 1≤Lamax/La≤2.4, with Lamax>1.5 mm and La≤1.5 mm,
1≤Lamax/La≤4.0, preferably 1≤Lamax/La≤3.2, with Lamax≤1.5 mm,
where Lamax is the maximum value of the widths of the axially inner portions of the transverse cuts of the N pairs of circumferentially adjacent transverse cuts,
   the mean angles of the axially inner portions of at least 25%, preferably at least 35% of the N pairs of N circumferentially adjacent transverse cuts are different.

In other words, at least 25%, at least 50% of the N pairs of circumferentially adjacent transverse cuts are sound dispersion pairs.

Similarly, in the case of a trio of circumferentially adjacent transverse cuts, some embodiments are such that, with the tyre comprising N circumferentially adjacent transverse cuts and N trios of transverse cuts which are circumferentially adjacent in a circumferential direction of rotation around the tyre, the width La of each axially inner portion of each of the N circumferentially adjacent transverse cuts is such that:
1≤Lamax/La≤2.5, preferably 1≤Lamax/La≤2.1, with Lamax>1.5 mm and Lai>1.5 mm,
1≤Lamax/La≤3.0, preferably 1≤Lamax/La≤2.4, with Lamax>1.5 mm and Lai≤1.5 mm,
1≤Lamax/La≤4.0, preferably 1≤Lamax/La≤3.2, with Lamax≤1.5 mm,
where Lamax is the maximum value of the widths of the axial portions of the transverse cuts of the N trios of circumferentially adjacent transverse cuts, the mean angles of the axial portions of at least 15%, preferably at least 20% of the N trios of N circumferentially adjacent transverse cuts are different in pairs.

In other words, at least 15%, at least 20% of the N pairs of circumferentially adjacent transverse cuts are sound dispersion trios.

In preferred embodiments for further improving the uniformity of wear of the tread, with the tyre comprising multiple sound dispersion pairs, each sound dispersion pair comprising first and second transverse cuts which are circumferentially adjacent in a circumferential direction of rotation around the tyre,
the difference in terms of absolute value between the first mean angle and the second mean angle of at least 25%, preferably at least 50% and more preferentially at least 75% of said sound dispersion pairs of circumferentially adjacent first and second transverse cuts is less than or equal to 20°.

In preferred variants for further reducing the noise generated by the tyre in sufficiently different use conditions, with the tyre comprising multiple sound dispersion pairs, each sound dispersion pair comprising first and second transverse cuts which are circumferentially adjacent in a circumferential direction of rotation around the tyre, the difference in terms of absolute value between the first mean angle and the second mean angle of at least 25%, preferably at least 50% and more preferentially at least 75% of said sound dispersion pairs of circumferentially adjacent first and second transverse cuts is greater than or equal to 5°, preferably greater than or equal to 10°.

Similarly to what has been optionally provided for the pairs of transverse cuts, the difference in terms of absolute value between one of the first, second and third mean angles and at least one of the others of the first, second and third mean angles of at least 25%, preferably at least 50% and more preferentially at least 75% of said sound dispersion trios of circumferentially adjacent first, second and third transverse cuts is less than or equal to 20° and/or greater than or equal to 5°, preferably greater than or equal to 10°.

In preferred but optional embodiments, each axially inner portion of each transverse cut of the or each sound dispersion pair or trio extends along an axial length equal to at least 20%, preferably at least 35% of the axial length of that part of each transverse cut of the sound dispersion pair or trio that is formed in the at least one of the first and second axially lateral portions.

The longer the axial length of the axial portion that contributes to dispersing noise is, the more noise generated by each transverse cut of the or each sound dispersion pair or trio is dispersed.

In some embodiments, the axially inner portion does not extend over the entire length of the axial portion of the at least one of the first and second axially lateral portions. In other embodiments, the axially inner portion extends over the entire length of the axial portion of the at least one of the first and second axially lateral portions.

As the tread is intended to come into contact with the ground, via the tread surface, when the tyre is running, the curvilinear length is therefore determined in the relevant portion of the tread and is therefore limited to the tread surface and therefore to the first and second axially lateral portions.

The axial length of a transverse cut part or a portion of a transverse cut, whether it belongs to a sound dispersion pair or trio or not, is the length measured along the axial direction between the two ends of the part of the transverse cut or the portion.

In some variants, each transverse cut of the or each sound dispersion pair or trio comprises an axially outer portion communicating with the axially inner portion and arranged axially on the outside of the axially inner portion, the axially outer portion being the axially outermost portion of each transverse cut of the or each sound dispersion pair or trio formed in the at least one of the first and second axially lateral portions.

In these variants, with preference, the axially outer portion of each transverse cut of the or each sound dispersion pair or trio extends in an overall direction forming a mean angle with the axial direction strictly less than the mean angle formed by the overall direction of the axially inner portion of at least one of the transverse cuts of the or each sound dispersion pair or trio.

Specifically, in the portion of the tread surface corresponding to the axial portion, the contact patch is straight. Conversely, in the portion of the tread surface corresponding to the axially outer portion, the contact patch is rounded owing to the curvature of the tyre. As a result, the leading edge of the axially inner portion comes into contact with the ground gradually, which is to say over a relatively long period of time, owing to the relatively large angle and the straightness of the contact patch in the axial portion, and this limits the noise compared to a cut that would form a substantially zero mean angle with the axial direction and the entire leading edge of which would come into contact with the ground at the same time. Similarly, owing to the smaller angle and the roundness of the contact patch in the axially outer portion, the leading edge also comes into contact with the ground gradually, and this also contributes to limiting the noise.

Thus, advantageously, in order to reduce the noise generated by each axially outer portion as far as possible, the mean angle formed by the overall direction of the axially outer portion with the axial direction is optionally strictly less than 25°, preferably less than or equal to 20° and more preferentially less than or equal to 15°.

The mean angle formed by the overall direction of the axially outer portion with the axial direction is preferably substantially the same for each transverse cut of the or each sound dispersion pair or trio.

Moreover, in optional embodiments, the axially outer portion has a width strictly greater than the width of the axial portion. As a result, the wide axially outer portion makes it possible to effectively discharge water out of the contact patch between the tread surface and the ground on which the tyre is running.

The axially outer portion optionally has a width ranging from 0.7 mm to 5.0 mm, preferably from 1.0 mm to 5.0 mm, preferably from 2.0 mm to 4.5 mm.

The axially outer portion optionally has a depth ranging from 2.0 mm to 5.5 mm.

In yet other embodiments, each transverse cut of the or each sound dispersion pair or trio comprises an axially terminal portion formed axially on the outside of the at least one of the first and second axially lateral portions and communicating with the wide axially outer portion. This promotes the discharge of water out of the contact patch between the tread surface and the ground on which the tyre is running.

The features described above relate to the transverse cuts formed in at least one of the first and second axially lateral portions. In some preferred embodiments, they may also be applied to the transverse cuts of the or each sound dispersion pair or trio formed in each first and second axially lateral portion.

In the conventional way, the tyre comprises a crown, two sidewalls, and two beads, each sidewall connecting each bead to the crown. Again in the conventional way, the crown comprises the tread and a crown reinforcement arranged radially on the inside of the tread. The tyre also comprises a carcass reinforcement that is anchored in each bead and extends radially in each sidewall and axially in the crown, radially on the inside of the crown reinforcement.

In the conventional way, the crown reinforcement comprises at least one crown layer comprising reinforcing elements. These reinforcing elements are preferably textile or metallic filamentary elements.

In embodiments for obtaining performance aspects of tyres known as radial tyres, for example as defined by the ETRTO, the carcass reinforcement comprises at least one carcass layer, the or each carcass layer comprising filamentary carcass reinforcing elements, each filamentary carcass reinforcing element extending substantially in a main direction that forms an angle, in terms of absolute value, ranging from 80° to 90° with the circumferential direction of the tyre.

The invention will be better understood on reading the following description, given solely by way of non-limiting example and with reference to the drawings, in which:

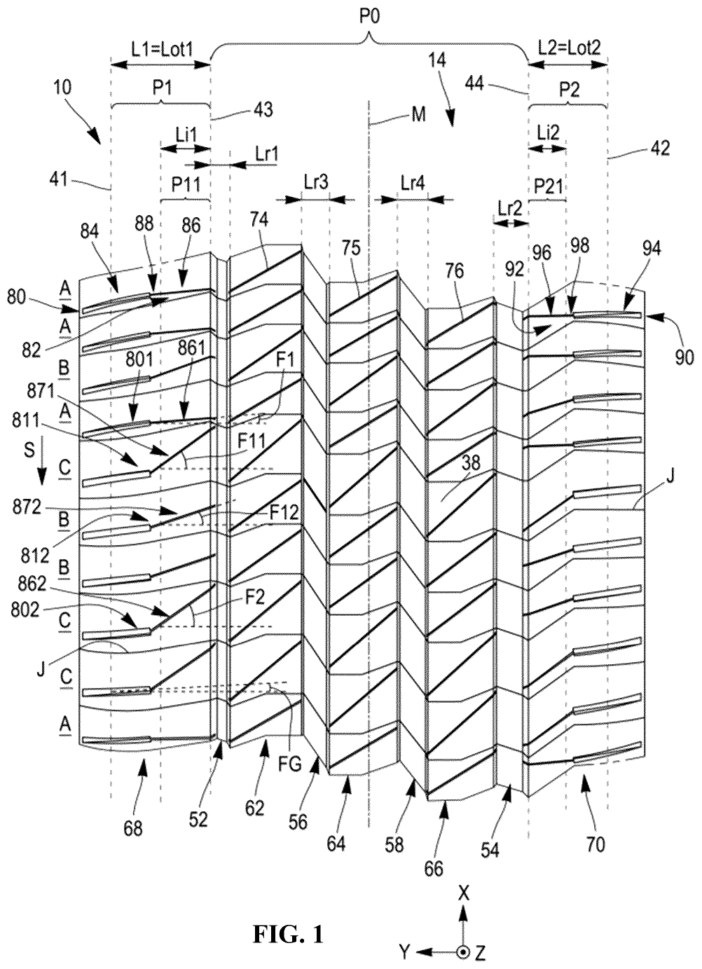

FIG. 1 is a top view of the tread of a tyre according to the invention,

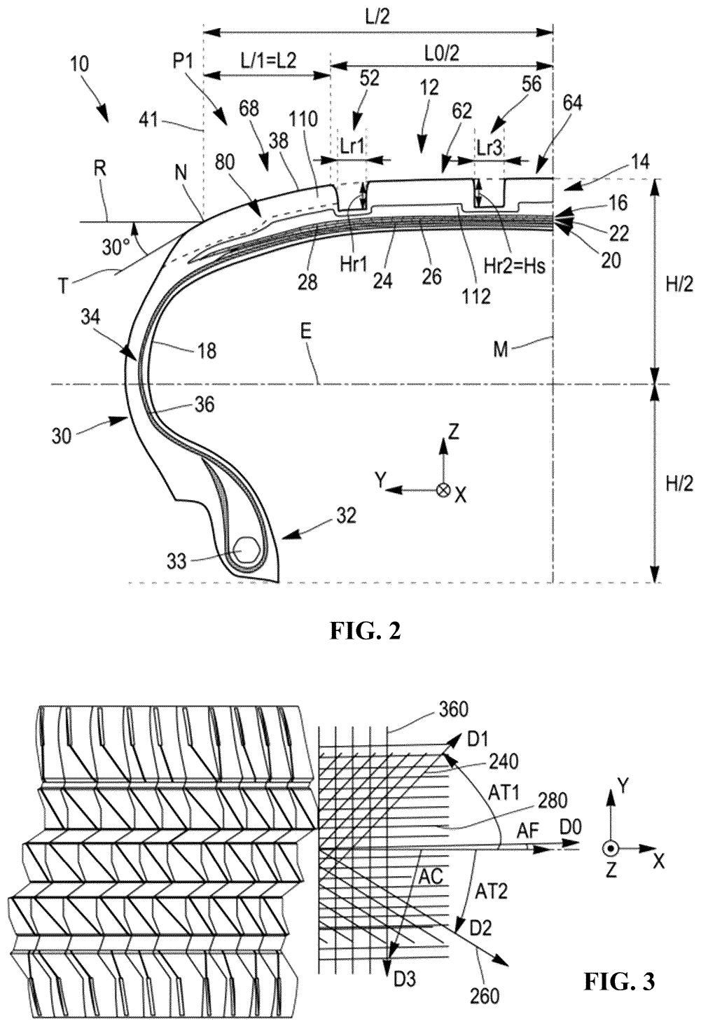

FIG. 2 is a view, in a meridian section plane parallel to the axis of rotation of the tyre, of the tyre in FIG. 1,

FIG. 3 is a cutaway view of the tyre in FIG. 1, illustrating the arrangement of the filamentary reinforcing elements in and under the crown,

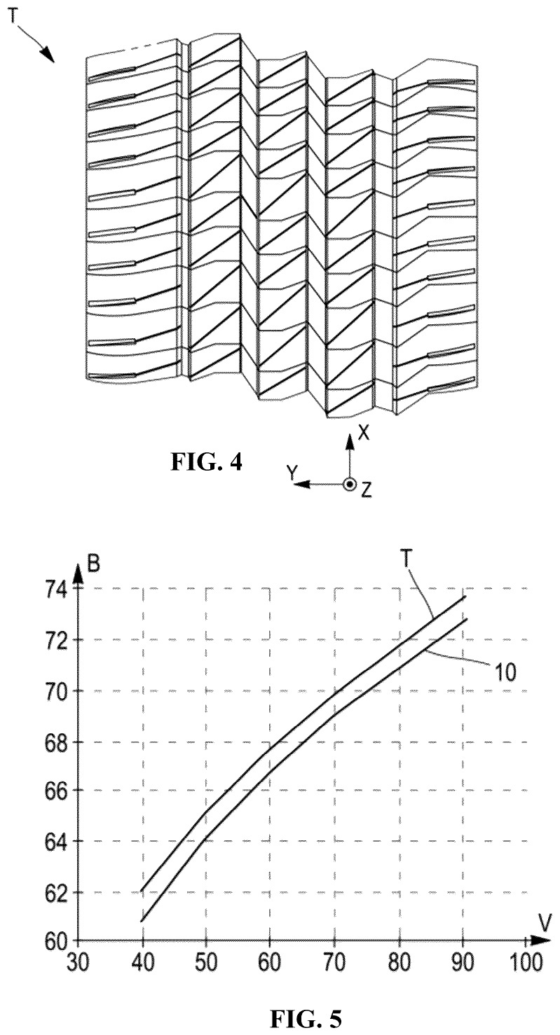

FIG. 4 is a view, similar to the one in FIG. 1, of a control tyre that makes it possible to demonstrate the advantage of the invention, and

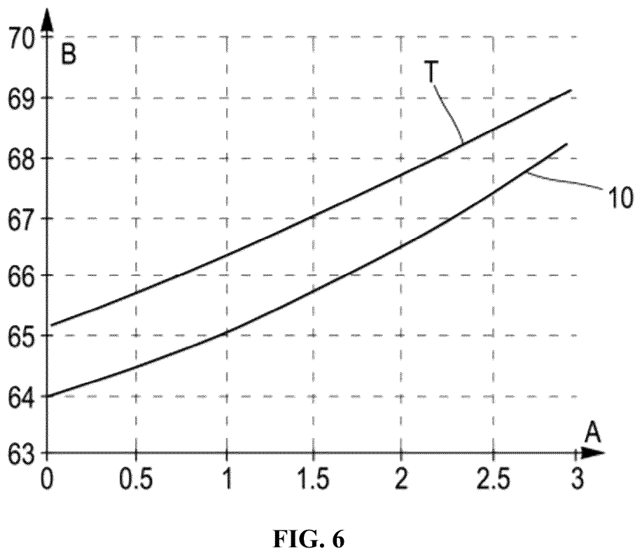

FIGS. 5 and 6 illustrate the results of comparative noise tests between the tyre according to the invention in FIG. 1 and the control tyre in FIG. 4.

A frame of reference X, Y, Z corresponding to the usual axial (Y), radial (Z) and circumferential (X) directions, respectively, of a tyre is shown in the figures relating to the tyre.

FIGS. 1 to 3 show a tyre according to the invention and denoted by the general reference 10. The tyre 10 has a substantially toric shape about an axis of revolution substantially parallel to the axial direction Y. The tyre 10 is intended for a passenger vehicle and is of size 205/55 R16. The tyre 10 is a summer tyre. In the various figures, the tyre 10 is depicted as new, which is to say when it has not yet been run.

With reference to FIG. 2, the tyre 10 comprises a crown 12 comprising a tread 14 intended to come into contact with the ground when the tyre is running and a crown reinforcement 16 extending in the crown 12 in the circumferential direction X. The tyre 10 also comprises a layer 18 that is airtight with respect to an inflation gas and is intended to delimit an internal cavity closed with a mounting support for the tyre 10 once the tyre 10 has been mounted on the mounting support, for example a rim.

The crown reinforcement 16 comprises a working reinforcement 20 and a hoop reinforcement 22. The working reinforcement 20 comprises at least one working layer and in this case comprises two working layers comprising a radially inner working layer 24 arranged radially on the inside of a radially outer working layer 26.

The hoop reinforcement 22 comprises at least one, in this case one hooping layer 28.

The crown reinforcement 16 is radially surmounted by the tread 14. In this case, the hoop reinforcement 22, in this case the hooping layer 28, is arranged radially on the outside of the working reinforcement 20 and is therefore interposed radially between the working reinforcement 20 and the tread 14.

The tyre 10 comprises two sidewalls 30 that continue the crown 12 radially towards the inside. The tyre 10 also comprises two beads 32 radially on the inside of the sidewalls 30. Each sidewall 30 connects each bead 32 to the crown 12.

The tyre 10 comprises a carcass reinforcement 34 that is anchored in each bead 32 and, in this instance, is wrapped around a bead wire 33. The carcass reinforcement 34 extends radially in each sidewall 30 and axially in the crown 12, radially on the inside of the crown reinforcement 16. The crown reinforcement 16 is arranged radially between the tread 14 and the carcass reinforcement 34. The carcass reinforcement 34 comprises at least one carcass layer 36.

With reference to FIG. 2, the tyre 10 comprises a tread layer 110 and a backing layer 112 for the tread layer 110. The backing layer 112 is arranged radially on the inside of the tread layer 110 and has a very low rolling resistance.

With reference to FIGS. 2 and 3, each working layer 24, 26, hooping layer 28 and carcass layer 36 comprises an elastomer matrix in which one or more filamentary reinforcing elements of the corresponding layer are embedded.

The hoop reinforcement 22, in this case the hooping layer 28, comprises one or more filamentary hoop reinforcing elements 280 that are wrapped circumferentially helically in a main direction DO that forms an angle AF which, in terms of absolute value, is less than or equal to 10°, preferably less than or equal to 7° and more preferentially less than or equal to 5° with the circumferential direction X of the tyre 10. In this case, AF=−5°.

Each radially inner working layer 24 and radially outer working layer 26 respectively comprises filamentary working reinforcing elements 240, 260 extending in main directions D1, D2 that form oppositely oriented angles AT1 and AT2, respectively, which, in terms of absolute value, are strictly greater than 10°, preferably range from 15° to 50° and more preferentially range from 15° to 30°, with the circumferential direction X of the tyre 10. In this case, AT1=−26° and AT2=+26°.

The carcass layer 36 comprises filamentary carcass reinforcing elements 360 extending in a main direction D3 forming an angle AC which, in terms of absolute value, is greater than or equal to 60°, preferably ranges from 80° to 90°, and in this case AC=+90°, with the circumferential direction X of the tyre 10.

Each filamentary hoop reinforcing element 280, working reinforcing element 240, 260 and carcass reinforcing element 360 is, for example, identical to those described in the applications WO2021250331, WO2022074341 and WO2022069819.

With reference to FIGS. 1 and 2, the tread 14 comprises a tread surface 38 via which the tread 14 comes into contact with the ground. The tread surface 38 is intended to come into contact with the ground when the tyre 10 is running on the ground. The tread surface 38 is axially delimited by first and second axial edges 41, 42 passing through each point N arranged on either side of the median plane M and for which the angle between the tangent T to the tread surface 38 and a straight line R parallel to the axial direction Y passing through this point is equal to 30°.

The tread 14 comprises an axially central portion P0 and first and second axially lateral portions P1, P2 arranged axially on the outside of the axially central portion P0 axially on either side of the axially central portion P0 with respect to the median plane M of the tyre 10. Each first and second axially lateral portion P1, P2 respectively has an axial width L1, L2 such that L1=30.3 mm and L2=25.4 mm.

The tread 14 comprises N>1 main circumferential cuts, in this case N main circumferential grooves, comprising first, second, third and fourth main circumferential cuts respectively denoted by reference signs 52, 54, 56, 58. The first and second main circumferential cuts 52, 54 are arranged axially on either side of the median plane M of the tyre 10 and are the axially outermost main circumferential cuts of the tread 14.

The first axially lateral portion P1 and the second axially lateral portion P2 are arranged axially on the outside of the first axially outer main circumferential cut 52 and the second axially outer main circumferential cut 54, respectively. The first axially lateral portion P1 extends axially from the first axial edge 41 of the tread surface 38 as far as the axially outer edge 43 of the first main circumferential cut 52. The second axially lateral portion P2 extends axially from the second axial edge 42 of the tread surface 38 as far as the axially outer edge 44 of the second main circumferential cut 54.

Each main circumferential cut 52 to 58 has a depth Hr ranging from 4.0 mm to the tread pattern height Hs, preferably ranging from 5.0 mm to the tread pattern height Hs and more preferentially ranging from 5.5 mm to the tread pattern height Hs. Each depth Hr is greater than or equal to 50% of the tread pattern height Hs. In this case, Hs=6.5 mm, Hr1=6.3 mm for each first and second axially outer main circumferential cut 52, 54 and Hr2=6.5 mm for each main circumferential cut 56, 58 of the axially central portion P0. Each main circumferential cut 52, 54, 56, 58 thus advantageously has a depth such that Hr1/Hs≥75%, Hr2/Hs≥75% and more preferably Hr1/Hs≥90%, Hr2/Hs≥90%.

Each main circumferential cut 52 to 58 respectively has an axial width Lr1, Lr2, Lr3, Lr4 greater than or equal to 1.0 mm, preferably greater than or equal to 5.0 mm and more preferentially ranging from 5.0 mm to 20.0 mm. In this case, Lr1=6.6 mm, Lr2=11.7 mm, Lr3=8.8 mm and Lr4=10.0 mm.

The axially central portion P0 comprises central ribs and in this case first, second and third central ribs respectively denoted by reference signs 62, 64, 66. Each central rib 62, 64, 66 is arranged axially between two of the adjacent main circumferential cuts 52 to 58.

Each central rib 62, 64, 66 comprises transverse cuts 74, 75, 76 having a width equal to 0.4 mm and a depth equal to 3.0 mm.

Each first and second axially lateral portion P1, P2 respectively comprises a first and a second lateral rib respectively denoted by reference signs 68, 70 and in this case is respectively made up of each first and second lateral rib 68, 70. Each first and second axially lateral portion P1, P2 comprises an axial portion P11, P21 having an axial width equal to 50% of the axial width L1, L2 of each first and second axially lateral portion P1, P2. Each axial portion P11, P21 extends axially outwards from each axially outer edge 43, 44 from which each first and second axially outer main circumferential cut 52, 54 extends.

The tread 14 comprises N transverse cuts 80, 90 formed partially in at least one of the first and second axially lateral portions P1, P2 and in this case formed at least partially respectively in each first and second axially lateral portion P1, P2. In this case, N=87. As a result, the N transverse cuts 80, 90 form N pairs of transverse cuts 80 which are circumferentially adjacent in a circumferential direction of rotation S around the tyre 10. Similarly, the tread 14 comprises N, in this case N=87, trios of transverse cuts 80 which are circumferentially adjacent in the circumferential direction of rotation S around the tyre 10. FIG. 2 shows the bottom of the cut 80 in dashed line.

Each transverse cut 80, 90, respectively comprises a narrow portion 82, 92 and a wide portion 84, 94.

Each narrow portion 82, 92 comprises an axially inner portion 86, 96 extending in the axial portion P11, P21 of each first and second axially lateral portion P1, P2. Each narrow portion 82, 92 also comprises an additional portion 88, 98 arranged outside the axial portion P11, P21 of each first and second axially lateral portion P1, P2.

Each wide portion 84, 94 comprises an axially outer portion and is in this case made up of an axially outer portion 84, 94 arranged outside the axial portion P11, P21 of each first and second axially lateral portion P1, P2. Each axially outer portion 84, 94 communicates respectively with each axially inner portion 86, 96 and is arranged axially on the outside respectively of each axially inner portion 86, 96.

Each axially inner portion 86, 96 is the axially innermost portion of each transverse cut 80, 90. Each axially inner portion 86, 96 leads respectively into each main circumferential cut 52, 54 adjacent to it.

Each axially outer portion 84, 94 is the axially outermost portion of each transverse cut 80, 90.

Each transverse cut 80, 90 extends along an axial length Lot1, Lot2 of that part of each transverse cut 80, 90 that is formed respectively in each first and second axially lateral portion P1, P2. In this case, Lot1=L1=30.3 mm and Lot2=L2=25.4 mm. Each axially inner portion 86, 96 of each transverse cut 80, 90 extends along an axial length Li1, Li2 equal to at least 20%, preferably at least 35% and in this instance equal to 50% of the axial length Lot1, Lot2 of that part of each transverse cut 80, 90 that is formed in each first and second axially lateral portion. In this case, Li1=15.2 mm and Li2=12.7 mm.

Each axially inner portion 86, 96 has a width La ranging from 0.2 mm to 2.2 mm, preferably from 0.2 mm to 1.0 mm, more preferentially from 0.2 mm to 0.6 mm and more preferentially still from 0.2 mm to 0.5 mm, and in this case La=0.4 mm. Each axially inner portion 86, 96 has a depth ranging from 2.0 mm to 5.5 mm, preferably ranging from 3.0 mm to 5.0 mm, and in this case equal to 4.5 mm.

Each axially outer portion 84, 94 has a width Lb strictly greater than the width respectively of each axially inner portion 86, 96. Each width Lb ranges from 0.7 mm to 5.0 mm, preferably from 1.0 mm to 5.0 mm and more preferentially from 2.0 mm to 4.5 mm, and in this case is equal to 2.3 mm, 2.8 mm or 3.3 mm depending on the pattern described below to which the cut belongs. Each axially outer portion 84, 94 has a depth ranging from 2.0 mm to 5.5 mm and in this case equal to 5.1 mm.

The tyre 10 is obtained by moulding a green tyre in a mould comprising a plurality of different patterns. In FIG. 1, the joins J between two circumferentially adjacent patterns are shown by continuous lines. In the present case, the mould comprises three different patterns which have been distributed randomly so as to mould the tread 14. The tread 14 thus comprises three different patterns A, B, C distributed in the circumferential direction of rotation S around the tyre as follows: AABACBBCCABCBABAAABBCBAABCCCBAAAABBCBCBAAA BCCCBAAAAAABCBCCCBAAAABCCBABCCCBAAAAAABCBABAB.

A description will now be given solely of the transverse cuts 80 formed at least partially in the first axially lateral portion P1. The features of the transverse cuts 90 formed at least partially in the second axially lateral portion P2 can be deduced therefrom, mutatis mutandis.

Each axially inner portion 86 of each transverse cut 80 of each pattern A, B, C extends in an overall direction forming respectively a non-zero mean angle with the axial direction Y. In the embodiment shown, the mean angle of the axially inner portion 86 of at least 25%, preferably at least 50% and more preferentially at least 75%, and in this case 100% of the transverse cuts 80 is equal to a value taken from a list of first, second and third values FA, FB, FC. The values of the angles FA, FB and FC are different in pairs. Each axially outer portion 84 of each transverse cut 80 extends in an overall direction forming a non-zero mean angle FG with the axial direction Y. The non-zero mean angle FG is substantially the same for each transverse cut 80.

More specifically, each mean angle of the axially inner portion 86 of at least 15%, preferably at least 25%, and in this case 41% of the transverse cuts 80 is equal to the first value FA, each mean angle of the axially inner portion 86 of at least 15%, preferably at least 25%, and in this case 32% of the transverse cuts 80 is equal to the second value FB, and each mean angle of the axially inner portion 86 of at least 15%, preferably at least 25%, and in this case 27% of the transverse cuts 80 is equal to the third value FC.

The mean angles of the axially inner portions 86 of at least 25%, preferably at least 35%, and in this case 61% of the N pairs of N circumferentially adjacent transverse cuts 80 are different.

The mean angles of the axially inner portions 86 of at least 15%, preferably at least 20%, and in this case 21% of the N trios of N circumferentially adjacent transverse cuts 80 are different in pairs.

Each non-zero mean angle of each axially inner portion 86, 96 is less than or equal to 50°. In this case, FA=5°, FB=25° and FC=45°. The mean angle FG is strictly less than 25°, preferably less than or equal to 20° and more preferentially less than or equal to 15°, and in this case is equal to 10°, irrespective of the pattern A, B, C.

The width La of each axially inner portion 86 of each of the N transverse cuts 80 is in this case such that 1≤Lamax/La≤4.0, preferably 1≤Lamax/La≤3.2, where Lamax is the maximum value of the widths of the axially inner portions 86 of the transverse cuts 80. In this instance, Lamax=La=0.4 mm.

The transverse cuts 80 formed in the first axially lateral portion P1 comprise multiple sound dispersion pairs and multiple sound dispersion trios, which will now be described in more detail.

In FIG. 1, which illustrates the arrangement of patterns AABACBBCCA, multiple sound dispersion pairs and trios can be determined. Some sound dispersion pairs and trios comprise transverse cuts 80 which are not circumferentially adjacent in the direction of rotation S and other sound dispersion pairs and trios comprise transverse cuts 80 which are circumferentially adjacent in the direction of rotation S.

With reference to FIG. 1, a description will first of all be given of the sound dispersion pairs comprising two transverse cuts 80 which are not circumferentially adjacent in the direction of rotation S and are exemplified by the example of the first and second transverse cuts 801, 802 and also of the sound dispersion pairs comprising two transverse cuts 80 which are circumferentially adjacent in the direction of rotation S and are exemplified by the example of the first and second transverse cuts 811, 812.

Each first and second transverse cut 801, 802 comprises an axially inner portion 861, 862 extending in an overall direction forming respectively a first non-zero mean angle F1 and a second non-zero mean angle F2 with the axial direction Y. The first mean angle F1 is different from the second mean angle F2. Similarly, each first and second transverse cut 811, 812 comprises an axially inner portion 871, 872 extending in an overall direction forming respectively a first non-zero mean angle F11 and a second non-zero mean angle F12 with the axial direction Y. The first mean angle F11 is different from the second mean angle F12.

The first and second mean angles F1, F2 and F11, F12 are equal to values taken from a list of at least first and second different values, in this case from a list of first, second and third values that are different in pairs, this list being made up of the values FA, FB, FC. In the pairs illustrated, F1=FA, F2=FC, F11=FC and F12=FB.

The difference in terms of absolute value between the first mean angle and the second mean angle of each of the sound dispersion pairs is less than or equal to 40° and is greater than or equal to 5°, preferably greater than or equal to 10°. In this case, |F1-F2|=40° and |F11-F12|=20°.

As regards the sound dispersion pairs comprising first and second transverse cuts which are circumferentially adjacent in the direction of rotation S, the difference in terms of absolute value between the first mean angle and the second mean angle of at least 25%, preferably at least 50%, and in this case 57% of the sound dispersion pairs of circumferentially adjacent first and second transverse cuts is less than or equal to 20° and greater than or equal to 5°, preferably greater than or equal to 10°. This 57% of sound dispersion pairs comprises the sound dispersion pair comprising the first and second transverse cuts 811, 812. Specifically, |F11-F12|=20°.

Still with reference to FIG. 1, a description will now be given of the sound dispersion trios comprising three transverse cuts 80 which are not circumferentially adjacent in the direction of rotation S and are exemplified by the example of the first, second and third transverse cuts 801, 812, 802 and also of the sound dispersion trios comprising three transverse cuts 80 which are circumferentially adjacent in the direction of rotation S and are exemplified by the example of the first, second and third transverse cuts 801, 811, 812.

In the case of the sound dispersion trio comprising the first, second and third transverse cuts 801, 812, 802 which are not circumferentially adjacent, the first, second and third mean angles F1, F12, F2 are different in pairs. Similarly, in the case of the sound dispersion trio comprising the first, second and third transverse cuts 801, 811, 812 which are circumferentially adjacent, the first, second and third mean angles F1, F11, F12 are different in pairs.

The first, second and third mean angles F1, F12, F2 and F1, F11, F12 are equal to values taken from a list of at least first, second and third different values, in this case from a list of first, second and third values that are different in pairs, this list being made up of the values FA, FB, FC.

The difference in terms of absolute value between the first mean angle and the second mean angle of each sound dispersion trio, the second mean angle and the third mean angle of each sound dispersion trio, the first mean angle and the third mean angle of each sound dispersion trio is less than or equal to 40° and greater than or equal to 5°, preferably greater than or equal to 10°. Here, in the case of the sound dispersion trio comprising the first, second and third transverse cuts 801, 812, 802 which are not circumferentially adjacent, |F1-F12|=20°, |F12-F2|=20° and |F1-F2|=40°. In the case of the sound dispersion trio comprising the first, second and third transverse cuts 801, 811, 812 which are circumferentially adjacent, |F1-F11|=40°, |F11-F12|=20° and |F1-F12|=20°.

As regards the sound dispersion trios comprising first, second and third transverse cuts which are circumferentially adjacent in the direction of rotation S, the difference in terms of absolute value between one of the first, second and third mean angles and at least one of the others of the first, second and third mean angles of at least 25%, preferably at least 50% and more preferentially at least 75%, and in this case 100% of the sound dispersion trios of circumferentially adjacent first, second and third transverse cuts is less than or equal to 20° and greater than or equal to 5°, preferably greater than or equal to 10°.

The non-zero mean angle FG of the axially outer portion 84, 94 of each transverse cut 80, 90 of each sound dispersion pair or trio is strictly less than the mean angle formed by the overall direction of the axially inner portion of at least one of the transverse cuts of each sound dispersion pair or trio, in this case less than the angles F2, F11 and F12.

### Comparative Tests

The tyre 10 described above was compared with a control tyre illustrated in FIG. 4 and denoted by the reference sign T. The control tyre T is identical to the tyre 10 except for the transverse cuts 80, 90, which are all identical to the cut 812 of the tyre 10.

The external noise generated by the tyre 10 and the control tyre T was measured, each in turn, by mounting them on the same vehicle running in the same conditions. The vehicle was made to run on a track in accordance with the ISO 10844 regulation and certified by UTAC. A delimited measuring zone on the track was fitted with a Müller-BBM vibroacoustic acquisition material. The noise measured in the field was corrected as a function of the temperature of the ground as indicated in the UN regulation no. R117.

In a first test, the noise generated by each tyre at different stable speeds of 40 km/h, 50 km/h, 60 km/h, 70 km/h, 80 km/h and 90 km/h were measured. FIG. 5 shows the external noise B, expressed in dB, generated by the tyre 10 and illustrated by the curve 10, and the external noise B, expressed in dB, generated by the tyre T and illustrated by the curve T for different stable speeds V expressed in km/h.

It will be observed that at 50 km/h and at 80 km/h, which are the conventional speeds for evaluating performance in terms of noise for a passenger vehicle tyre representing urban and peri-urban use conditions, the tyre 10 generates a noise at least 1 dB lower than that of the control tyre T, representing a significant improvement in these two use conditions.

A second test was used to measure the noise generated by each tyre when a speed of 50 km/h was reached at different accelerations. Upon reaching this speed of 50 km/h, the acceleration of the vehicle was also measured. FIG. 6 shows the external noise B, expressed in dB, generated by the tyre 10 and illustrated by the curve 10, and the external noise B, expressed in dB, generated by the tyre T and illustrated by the curve T for different accelerations A expressed in m/s−2.

Here, too, it will be observed that, irrespective of the acceleration used, the tyre 10 generates a noise at least 1 dB lower than that of the control tyre T, representing a significant improvement irrespective of the acceleration conditions.

The invention is not limited to the embodiment described above.

Specifically, embodiments in which the transverse cuts formed in the or one of the first and second axially lateral portions do not all belong to sound dispersion pairs or trios may be envisaged. Thus, in a variant of the preceding embodiment, in addition to transverse cuts 80, 90, transverse cuts which are all identical and have a width La1 for example equal to 3.0 mm may be possible. These transverse cuts do not satisfy the relationship 1≤La1/La2≤3.0 (in this case La2=0.5 mm and La1>1.5 mm) and therefore do not belong to the sound dispersion pairs or trios.

In other embodiments, each first, second and third non-zero mean angle of the axially inner portion of each first, second and third transverse cut of each sound dispersion pair or trio is less than or equal to 50°, preferably less than or equal to 40°, and more preferentially ranges from 5° to 40°. For example, FA=8°, FB=27° and FC=35° may be conceivable.

In yet other embodiments, it could also be envisaged that the tread does not have any sound dispersion trios and has only sound dispersion pairs.

1.-15. (canceled)

16. A tire for a passenger vehicle, the tire comprising a tread intended to come into contact with a ground via a tread surface when the tire is running, the tread comprising:
main circumferential cuts having a depth greater than or equal to 50% of a tread pattern height, comprising first and second axially outer main circumferential cuts arranged axially on either side of a median plane of the tire, the first and second axially outer main circumferential cuts being axially outermost main circumferential cuts of the tread;
a first axially lateral portion arranged axially on an outside of the first axially outer main circumferential cut and extending axially from a first axial edge of the tread surface to an axially outer edge of the first axially outer main circumferential cut;
a second axially lateral portion arranged axially on an outside of the second axially outer main circumferential cut and extending axially from a second axial edge of the tread surface to an axially outer edge of the second axially outer main circumferential cut,
at least one of the first and second axially lateral portions comprising an axial portion having an axial width equal to 50% of an axial width of the at least one of the first and second axially lateral portions and extending axially outwards from the axially outer edge of the first or second axially outer main circumferential cut from which the at least one of the first and second axially lateral portions extends,
wherein the tread comprises at least transverse cuts formed at least partially in at least one of the first and second axially lateral portions,
each transverse cut comprising an axially inner portion extending in the axial portion of the at least one of the first and second axially lateral portions,
the transverse cuts formed in the at least one of the first and second axially lateral portions comprising at least one sound dispersion pair comprising a first and a second transverse cut, each axially inner portion of each first and second transverse cut of the at least one sound dispersion pair respectively having a width La1, La2 such that:
1≤La1/La2≤2.5 with La1>1.5 mm and La2>1.5 mm,
1≤La1/La2≤3.0 with La1>1.5 mm and La2≤1.5 mm, and
1≤La1/La2≤4.0 with La1≤1.5 mm,
each axially inner portion of each first and second transverse cut of the at least one sound dispersion pair extends in an overall direction respectively forming a first and a second non-zero mean angle with an axial direction, and
a first mean angle of the axially inner portion of the first transverse cut of the at least one sound dispersion pair is different from a second mean angle of the axially inner portion of the second transverse cut of the at least one sound dispersion pair.

17. The tire according to claim 16, wherein each first and second non-zero mean angle of the axially inner portion of each first and second transverse cut of the at least one sound dispersion pair is less than or equal to 50°.

18. The tire according to claim 16, wherein a difference in terms of absolute value between the first mean angle and the second mean angle of the at least one sound dispersion pair is less than or equal to 40°.

19. The tire according to claim 16, wherein a difference in terms of absolute value between the first mean angle and the second mean angle of the at least one sound dispersion pair is greater than or equal to 5°.

20. The tire according to claim 16, wherein, with the first and second mean angles being equal to values taken from a list of at least first and second different values:
the mean angle of the axially inner portion of at least 25% of the transverse cuts of the at least one of the first and second axially lateral portions is equal to one of the at least first and second different values, and
each axially inner portion of each transverse cut of which the mean angle is equal to one of the at least first and second different values has a width La such that:
1≤Lamax/La≤2.5, with Lamax>1.5 mm and La>1.5 mm,
1<Lamax/La≤3.0, with Lamax>1.5 mm and La≤1.5 mm, and
1≤Lamax/La≤4.0, with Lamax≤1.5 mm,
where Lamax is a maximum value of the widths of the axially inner portions of at least 25% of the transverse cuts of which the mean angle is equal to one of the at least first and second different values.

21. The tire according to claim 20, wherein each mean angle of the axially inner portion of at least 15% of the transverse cuts of the at least one of the first and second axially lateral portions is equal to the first value, and
wherein each mean angle of the axially inner portion of at least 15% of the transverse cuts of the at least one of the first and second axially lateral portions is equal to the second value.

22. The tire according to claim 16, wherein the transverse cuts formed at least partially in the at least one of the first and second axially lateral portions comprise at least one sound dispersion trio comprising a first, a second and a third transverse cut,
wherein each first, second and third transverse cut of the at least one sound dispersion trio comprises an axially inner portion extending in the axial portion of the at least one of the first and second axially lateral portions,
wherein each axially inner portion of each first, second and third transverse cut of the at least one sound dispersion trio respectively has a width La1≥La2≥La3 such that:
1≤La1/La3≤2.5, with La1>1.5 mm and La3>1.5 mm,
1≤La1/La3≤3.0, with La1>1.5 mm and La3≤1.5 mm, and
1≤La1/La3≤4.0, with La1≤1.5 mm,
wherein each axially inner portion of each first, second and third transverse cut of the at least one sound dispersion trio extends in an overall direction respectively forming a first, a second and a third non-zero mean angle with the axial direction, and
wherein the first, second and third mean angles of the axially inner portions of the first, second and third transverse cuts of the at least one sound dispersion trio are different in pairs.

23. The tire according to claim 22, wherein, with the first, second and third mean angles being equal to values taken from a list of at least first, second and third values that are different in pairs:
the mean angle of the axially inner portion of at least 25% of the transverse cuts of the at least one of the first and second axially lateral portions is equal to one of the at least first, second and third different values, and
each axially inner portion of each transverse cut of which the mean angle is equal to one of the at least first, second and third different values has a width La such that:
1<Lamax/La≤2.5, with Lamax>1.5 mm and La>1.5 mm,
1≤Lamax/La≤3.0, with Lamax>1.5 mm and La≤1.5 mm, and
1≤Lamax/La≤4.0, with Lamax≤1.5 mm,
where Lamax is a maximum value of the widths of the axially inner portions of at least 25% of the transverse cuts of which the mean angle is equal to one of the at least first, second and third values that are different in pairs.

24. The tire according to claim 23, wherein each mean angle of the axially inner portion of at least 15% of the transverse cuts of the at least one of the first and second axially lateral portions is equal to the first value,
wherein each mean angle of the axially inner portion of at least 15% of the transverse cuts of the at least one of the first and second axially lateral portions is equal to the second value, and
wherein each mean angle of the axially inner portion of at least 15% of the transverse cuts of the at least one of the first and second axially lateral portions is equal to the third value.

25. The tire according to claim 16, wherein the first and second transverse cuts of the at least one sound dispersion pair are circumferentially adjacent.

26. The tire according to claim 25, wherein a difference in terms of absolute value between the first mean angle and the second mean angle of the at least one sound dispersion pair of circumferentially adjacent first and second transverse cuts is less than or equal to 20°.

27. The tire according to claim 25, wherein a difference in terms of absolute value between the first mean angle and the second mean angle of the at least one sound dispersion pair of circumferentially adjacent first and second transverse cuts is greater than or equal to 5°.

28. The tire according to claim 16, wherein, with the tread comprising N circumferentially adjacent transverse cuts forming N pairs of transverse cuts which are circumferentially adjacent in a circumferential direction of rotation around the tire, the width La of each axially inner portion of each of the N circumferentially adjacent transverse cuts is such that:
1≤Lamax/La≤2.5, with Lamax>1.5 mm and La>1.5 mm,
1≤Lamax/La≤3.0, with Lamax>1.5 mm and La≤1.5 mm, and
1≤Lamax/La≤4.0, with Lamax≤1.5 mm,
where Lamax is a maximum value of the widths of the axially inner portions of the transverse cuts of the N pairs of circumferentially adjacent transverse cuts, and
wherein the mean angles of the axially inner portions of at least 25% of the N pairs of N circumferentially adjacent transverse cuts are different.

29. The tire according to claim 16, wherein the tire comprises multiple sound dispersion pairs, each sound dispersion pair comprising first and second transverse cuts which are circumferentially adjacent in a circumferential direction of rotation around the tire,
a difference in terms of absolute value between the first mean angle and the second mean angle of at least 25% of the sound dispersion pairs of circumferentially adjacent first and second transverse cuts is less than or equal to 20°.

30. The tire according to claim 16, wherein the tire comprises multiple sound dispersion pairs, each sound dispersion pair comprising first and second transverse cuts which are circumferentially adjacent in a circumferential direction of rotation around the tire,
a difference in terms of absolute value between the first mean angle and the second mean angle of at least 25% of the sound dispersion pairs of circumferentially adjacent first and second transverse cuts is greater than or equal to 5°.
